(19) United States
(12) Patent Application Publication
(10) Pub. No.: US 2019/0019407 A1
(43) Pub. Date: Jan. 17, 2019

(54) Real time parking lot analysis and management

(71) Applicant: OMID B. NAKHJAVANI, KIRKLAND, WA (US)

(72) Inventor: OMID B. NAKHJAVANI, KIRKLAND, WA (US)

(21) Appl. No.: 15/993,542

(22) Filed: May 30, 2018

Related U.S. Application Data
(60) Provisional application No. 62/532,471, filed on Jul. 14, 2017.

(51) Int. Cl. G08G 1/01; G08G 1/14; G08G 1/123; G06T 11/60; G06K 9/00; G06Q 20/10; G07B 15/02

(52) U.S. Cl. CPC G08G 1/0137; G08G 1/144; G08G 1/123; G06T 11/60; G05D 1/021; G08G 1/146; G06Q 20/10; G07B 15/02; G06K 9/00812

(57) ABSTRACT

A method to find and report an available parking space in a parking lot, where a software application is installed on a memory device coupled to a processor on a dedicated computing platform in an automobile. The dedicated computing platform further including a geographic localizing program, a mapping software providing a digital parking space map superimposed on a real map of the parking lot, a statistical analysis software calculating probability of occupied or available status of a parking space based on data provided by the dedicated computing platform, a transceiver transmitting availability status of the parking space in the parking lot to a central processing unit. Where the central processing unit further transmits availability status of the parking spaces in the parking lots to the dedicated computing platform, thus enabling the dedicated computing platform to report on available parking spaces in the parking lots.

### CROSS-REFERENCE TO RELATED APPLICATIONS

This application claims priority under 35 U.S.C. § 119 to U.S. Provisional Application 62/532,471 filed on Jul. 14, 2017, which is incorporated herein by reference in its entirety.

### FIELD OF THE DISCLOSURE

The present disclosure relates to systems and methods for identifying an available parking space in a parking lot and reporting of the same, and in particular to a software application on a mobile phone or a computing platform analyzing availability of an available parking space, transmitting information on the available parking space to a central processing unit, and the central processing unit broadcasting the information to a plurality of computing platforms.

### BACKGROUND OF THE DISCLOSURE

Using a personal automobile for traveling to a destination instead of using public transportation provides convenience, ease of scheduling a trip, and an assurance of timely availability of the automobile for the return trip.

One of the challenges of using a personal automobile is finding an available parking space proximate to one's destination. It is often difficult to know of availability of a parking space in a parking lot proximate to the destination. A driver has to search looking for an available parking space in a parking lot, driving in downtown traffic when she may have a time constraint as to her destination.

This situation applies whether the driver's destination is a business place down town or a sporting event where a large number of attendees are in search of a limited number of available parking spaces close to their destination. A similar problem also presents itself in parking lots in large universities or large corporations, where a driver needs to attend a class or a meeting starting at a specific time and all the proximate parking spaces are occupied and driver needs to drive through the parking lot to find an available parking space in a timely manner.

A driver can search on the internet and find the address to her destination along with the address to pay parking facilities proximate to her destination before she leaves. However even if the parking facilities provide updated information on availability of parking spaces in their lots on their website, because there is a time lag between when she gets the information from the internet and when she arrives at the parking facility, the parking facility may be fully occupied, where the deriver will again faces the problem of finding an available parking space.

The process for finding an available parking space, usually results in driver's frustration, wasted driver's time, wasted gas or electricity by the automobile driving around in traffic looking for an available parking space in a parking lot. In situations where the driver had not allowed for enough driving search time, a delay in finding a parking space will further result in the driver missing the start time of a business meeting, a class, an entertainment or sporting event.

A system that can analyze availability of a parking space in a parking lot and provide real time information on available parking spaces in a parking lot proximate to the driver's destination will provide the driver with choices to decide where she can park to optimize the distance from the parking space to her destination and associated parking expenses.

### SUMMARY OF THE DISCLOSURE

To address solutions to the problem detailed above the present disclosure provides a method, apparatus and system to find and report an available parking space in a parking lot. The system includes a software application on a memory device coupled to a processor on a dedicated computing platform in an automobile. The dedicated computing platform further includes a geographic localizing program, a mapping software providing a digital parking space map superimposed on a real map of the parking lot, a statistical analysis software calculating probability of occupied or available status of a parking space based on data provided by the dedicated computing platform, and a transceiver transmitting availability status of the parking space in the parking lot to a central processing unit. The central processing unit further transmits availability status of the parking spaces in the parking lots to the dedicated computing platform, and the dedicated computing platform reports on available parking spaces in the parking lots.

Furthermore, the geographic localizing program uses a global positioning system or a triangulating system based on radio frequency sources including cellular phone towers, and identifies geographic position of the dedicated computing platform. The digital parking space map superimposed on a real map of the parking lot is created using a web based sketching tool software mapping a configuration of the plurality of parking spaces on the real map image of the parking lot, resulting in digital representation of individual parking spaces in the parking lot.

In the present disclosure the software algorithm is capable of assigning occupied or available status to each individual parking space based on a statistical analysis of information provided to it.

In the present disclosure a plurality of automobiles are each equipped with the dedicated computing platform equipped with the transceiver communicating with the central processing unit, where the dedicated computing platform is in communication with the central processing unit. The dedicated computing platform can identify geographic location of the automobile and can sense movement, speed, acceleration, and temporary and permanent stoppage of the automobile.

The dedicated computing platform in each automobile transmits to the central processing unit when the automobile is parked in a specific parking space on the parking lot, and will also inform the central processing unit when the automobile leaves the specific parking space, providing a definite occupied or available status for the specific parking space,

The dedicated computing platform can further identify if the automobile is slow loitering about the specific parking space in the parking lot and moving on, indicating that the specific parking space may be occupied, even though another automobile with a dedicated computing platform has not reported parking in that specific parking space providing a definite occupied or available status of the specific parking space. Here a repeated slow loitering report from a plurality of dedicated computing platforms provides a statistical probability that the specific parking space is occupied. Here the status of the specific parking space is updated as occupied as part of updating parking space status for all the parking spaces of the parking lot on the central processing unit. Consequently the software application in communication with the central processing unit can provide real time parking space availability in the parking lot to the operator of the automobiles equipped with a dedicated computing platform.

Another embodiment of this disclosure details a parking lot with a plurality of different levels from ground, and where the dedicated computing platform on each automobile is equipped with a pressure sensor, capable of identifying height variation due to spatial location of the automobile in different levels of the parking lot based on increasing or decreasing atmospheric pressure, further distinguishing the random instantaneous atmospheric pressure variation from continuous increase or decrease in atmospheric pressure, identifying location of parking spaces on different parking levels of the parking lots with multi-level floors.

Accordingly, the central processing unit provides a two dimensional sketch of the ground level parking lots and a three dimensional sketch of multi-level floors parking lots specifying individual parking spaces on the ground level or above ground floors and corresponding available parking spaces to the dedicated computing platform on each automobile inquiring about available parking spaces.

An alternative to a pressure sensor on the dedicated computing platform to identify moving between floors in a multi-level parking lot is by statistically calculating probability of moving between floors based on spatial location of the automobile and speed of the automobile, where with the automobile moving in a very limited area, yet maintaining a constant linear speed indicating that the automobile is moving between floor, and not moving across a single floor.

In yet another embodiment the dedicated computing platform on each automobile is equipped with a gyroscope or a three axis orthogonal accelerometer system to detect Yaw, Pitch, and roll of the dedicated computing platform and the automobile within which the dedicated computing platform resides. Here the automobiles moving from a floor to the next floor will go through a change of its yaw, pitch and roll identifying a movement of the automobile to a different floor level. A change of yaw of the automobile between about less than or equal to 90 degrees and a reduction of the speed of the automobile to zero indicates that the automobile has parked in a parking space, and a change of yaw of the automobile about 180 degrees and a continued movement of the automobile indicates that the automobile has turned around.

In another embodiment, the method to find and report the available parking space in the parking lot further includes an unmanned aerial vehicle, using a camera for identifying the occupied parking spaces in the parking lot, an autonomous automobile using cameras detecting occupied parking spaces in the parking lot, or using a radio frequency detector identifying presence of dedicated computing platforms within or proximate to the parking space in the parking lot.

In one embodiment the central processing unit has information on address of the parking lots and associated parking rates to be provided to the dedicated computing platform when responding to an inquiry about available parking spaces. The dedicated computing platform is further capable of making electronic payments for parking in the parking lot to an account of the parking lot registered with the central processing unit.

Depending on multiple inquiries on available parking spaces from multiple automobile operators in a specific locality the central processing unit, when previously authorized by the parking lot, can alter the parking fee associated with the parking lot for attracting potential automobile operators in search of the parking space to increase revenue for the parking lot on a real time basis, and when there are not as much demand for parking space the reported parking fee by the central processing unit is reduced compared to close by parking lots.

In one embodiment the central processing unit has information on specific parking spaces in the parking lot dedicated to handicapped parking, electric charging station parking spaces for electric automobiles, specific time limits on parking spaces, temporary unavailability of the available parking space used for specific non-parking related activity such as storage of equipment, or a combination thereof, to be provided to the dedicated computing platform upon inquiry as to available parking spaces.

Furthermore, the central processing unit attains information as to traffic flow in a locality using department of transportation website or street based traffic video cameras, from Google Traffic application recognizing traffic flow based on general information provided from driver's mobile phone report to Google Map application, individuals, the dedicated computing platforms, the operators of automobiles with the dedicated computing platform, the unmanned aerial vehicle, or a combination thereof.

In one embodiment the central processing unit assigns parking space numbers to each identified parking space as mapped on a parking area in the parking lot, for specific allocation and reporting of occupied or available parking spaces in response to an inquiry from the dedicated computing platform on available parking space.

An operator of the automobile with the dedicated computing platform can further provide information to the central processing unit as to status of individual parking spaces in the parking lot as to it being occupied or available, in addition to the dedicated computing platform automatic reporting of the automobile slow loitering and moving on from a parking space. Furthermore, the dedicated computing platform can autonomously identify if the automobile is parking in the parking space or leaving the parking space based on deceleration or acceleration movement of the automobile or movement time delays or a specific speed threshold.

The central processing unit can further provide information as to where the automobile is parked upon inquiry from the dedicated computing platform when the automobile operator does not remember where the automobile operator had parked the automobile in the parking lot. For when the automobile operator is carrying the dedicated computing platform, the dedicated computing platform, using a speed of moving of the dedicated computing platform can decide if the dedicated computing platform is in the automobile or it is on the automobile operator and when the dedicated computing platform is on the automobile operator while walking, the dedicated computing platform will not report to the central processing unit that the automobile has departed the parking space. The dedicated computing platform on the automobile operator will not report departure of the automobile to the central processing unit, unless the dedicated computing platform recognizes its location within the parking lot after the automobile operator walks back to her automobile for departing the parking space. In case there are multiple dedicated computing platforms in a single automobile where several people with a mobile phone activated dedicated computing platforms are in the single automobile, the central processing unit can combine the geographic location report by all the dedicated computing platforms in the single automobile and associate all the reports to a single parking space when the automobile is parked in the parking space.

In one embodiment the statistical probability of available parking spaces in a zone, as reported by the central processing unit to dedicated computing platforms inquiring about available parking spaces, takes into account occupancy probability of a general parking zone adjacent to a favorable area in statistical calculation of available parking spaces in the zone.

In an embodiment where an autonomous public transportation vehicle is operating, the available parking information is transmitted to the autonomous public transportation vehicle, identifying an available parking or stopping location in a desired vicinity on a route of the autonomous public transportation vehicle, enabling safe embarking and egress of passengers.

When the autonomous public transportation vehicle is operational, the autonomous public transportation vehicle further transmits a number of available seats in the autonomous public transportation vehicle, the route of the autonomous public transportation vehicle, and stopping locations of the autonomous public transportation vehicle, to be posted to a website, where passengers can reserve the available seats on the autonomous public transportation vehicle and proceed to the nearest stopping location to embark on the autonomous public transportation vehicle.

In yet another embodiment a business method is disclosed where a central processing unit identifying available parking spaces can guide a dedicated computing platform in an automobile inquiring about available parking spaces toward specific parking zones to increase traffic flow to a specific adjacent commercial space when the commercial space pays a fee for increased traffic to their locality to be enabled by the central processing unit influencing a bias for providing information on available parking spaces in the preferred zone.

### BRIEF DESCRIPTION OF THE DRAWINGS

Further features of the present disclosure are set forth in the detailed description and in the drawings figures. Referring to the drawings in which like reference numbers represent corresponding parts throughout:

FIG. 1 is an illustration of a parking lot superimposed by a digital parking space map,

FIG. 2 is an illustration of a parking lot superimposed by a digital parking space map and cell phone towers also showing an autonomous public transportation vehicle,

FIG. 3 is an illustration of a multi-level parking lot,

FIG. 4 is an illustration of an automobile driving on an inclined road showing roll, pitch and yaw orientation of the automobile.

FIG. 5 is an illustration of a computer connected to a web based sketching tool software.

FIG. 6 is an illustration of a dedicated computing platform.

FIG. 7 is an illustration of a business method for bias guidance of inquiring dedicated computing platform to a specific parking zone for a fee.

Each figure shown in this disclosure shows a variation of an aspect of the embodiments presented, and only differences will be discussed in detail.

### DETAILED DESCRIPTION

Generally the present disclosure titled real time parking lot analysis and management describes a system comprising a plurality of dedicated computing platform including lap tops, cell phones or tablets, inside vehicles including automobiles, buses, or unmanned aerial vehicles with a software application encoded on a memory device on the dedicated computing platform, where the dedicated computing platforms are in communication with a central processing unit also with an encoded computer program on a memory device.

The real time parking lot analysis and management system uses individual dedicated computing platforms to identify available and occupied parking spaces in parking lots and then on a real time basis communicate the information on available and occupied parking spaces in the parking lot to the central processing unit, where the central processing unit makes the information on parking space availability in different parking lots available to all linked dedicated computing platforms in communication with the central processing unit. The information further include address and name of the parking lot, and may include parking fees and overall parking lot zone parking space availability information. The statistical probability of available parking spaces in a zone, as reported by the central processing unit to dedicated computing platforms inquiring about available parking spaces, takes into account occupancy probability of a general parking zone adjacent to a favorable area in statistical calculation of available parking spaces in the zone. The zone covers the overall parking lot parking spaces.

An unmanned aerial vehicle using a camera, observes open air parking lots, and communicates the parking space status and overall parking lot zone available parking space information to the central processing unit. Furthermore a driverless autonomous automobile using cameras can detect occupied and available parking spaces in the parking lot, or the autonomous automobile can use a radio frequency detector identifying presence of dedicated computing platforms within or proximate to a parking space in the parking lot identifying the parking space as occupied.

A driver of a vehicle, or alternatively an autonomous automobile equipped with cameras and sensors, and equipped with a dedicated computing platform can communicate information on occupied and available parking spaces in a parking lot to the central processing sensor.

A dedicated computing platform, further equipped with a geographical localizing program including a global positioning system or a system using triangulating radio frequency (RF) from RF sources including cellular phone towers to locate geographic and potential spatial coordination of the dedicated computing platform, an accelerometer, a speed sensor, an atmospheric pressure sensor, a gyroscope, or a combination hereof, can sense movement of the automobile in vicinity of parking spaces. When an automobile enters a parking space, stops and occupies the parking space the dedicated computing platform sensing movement and stoppage of the automobile will communicate with the central processing unit that that parking space is occupied and will further communicate availability of the parking space when the automobile departs the parking space. Furthermore when the dedicated computing platform equipped automobile in a low speed loiters proximate to a plurality of parking space in a parking lot, it can statistically calculate a probability that the proximate parking spaces are occupied. If several automobile equipped with dedicated computing platforms further provide the same statistical analysis to the central processing unit, the central processing unit can provide a probability estimate of what parking spaces in a parking lot are occupied or are available to linked dedicated computing platforms inquiring about available parking spaces in different parking lots. This statistical analysis feature based on sensing slow speed loitering of dedicated computing platform equipped automobiles is used when a parking space is occupied by an automobile, which is not equipped with a dedicated computing platform to communicate occupied status of the parking space that it is using.

A dedicated computing platform, such as a mobile phone, further may have the capability of making electronic payments for parking in the parking lot to an account of the parking lot registered with the central processing unit using a bank account, a credit card or bit coins.

As it relates to multi-level parking lots, the roll, pitch, yaw sensors, in addition to atmospheric pressure sensors and accelerometer and speed sensors in a dedicated computing platform can detect movement of the automobile between different floors of the multi-level parking lot in performing its statistical analysis based on slow or fast speed loitering next to parking spaces in providing a probability estimate as to available or occupied parking spaces on different levels. The atmospheric pressure sensor can detect variation in height indicating going from one level to another level of the multi-level parking lot by sensing the atmospheric pressure variation. The dedicated computing platform can distinguish between continuous increase or decrease of the atmospheric pressure indicating movement between floor as opposed to random instantaneous atmospheric pressure variation. Another method for the dedicated computing platform to statistically decide if the vehicle is moving between floors in a multi-level parking space is by statistically calculating probability of moving between floors based on spatial location of the automobile and the speed of the automobile, where with the automobile moving in a very limited area, yet maintaining a constant linear speed indicating that the automobile is moving between floors and not moving across a single floor. Yet another method used by a dedicated computing platform in deciding movement between floors is using a gyroscope or a three axis orthogonal accelerometer system to detect yaw, pitch and roll of the dedicated computing platform inside the automobile. The dedicated computing platform sensing of the a change in yaw, pitch and roll of the moving automobile identifies a movement of the automobile to a different floor level. Furthermore a change of yaw of the automobile between about less than or equal to 90 degrees and a reduction of speed of the automobile to zero indicates that the automobile is parked in a parking space, and change of yaw of the automobile about 180 degrees and followed by a continued movement of the automobile indicates that the automobile has turned around.

For each parking lot, including open air parking lots and multi-level parking lots an operator generates a digital parking space map comprising a two dimensional map for an open air parking lot or a three dimensional map for a multi-level parking lot, using a web based sketching tool software, identifying parking spaces and providing parking space numbers for the digital parking space map to be superimposed on an image of the parking lot, to be displayed on a display of the dedicated computing platform to identify available or occupied parking spaces' information in addition to other designated parking spaces such as handicapped parking space, electric vehicle charging parking space and public transportation stopping parking space at a desired parking lot as inquired by the dedicated computing platforms. The digital parking space map can be updated on a real time basis to show available parking spaces or use marking to identify occupied parking spaces or provide a probability of availability of a parking space based on statistical analysis done by the dedicated computing platforms, which is communicated to the central processing unit.

Another utility of the real time parking lot analysis and management in identifying available parking spaces in a parking lot is to provide information on a stopping place to be used by an autonomous public transportation vehicle where passengers can embark (get on the vehicle) and egress (get off the vehicle) the driverless autonomous public transportation vehicle. The autonomous public transportation vehicle can communicate with the central processing unit its route and time of arrival at the next stopping location, and also provide information on how many available seats are onboard the autonomous public transportation vehicle. Passenger using a portable dedicated computing platform, such as a mobile phone, can access the autonomous public transportation vehicle information and arrange to be at the stopping location to get on the autonomous public transportation vehicle and go to their destination along the autonomous public transportation vehicle route. The stopping parking space for the autonomous public transportation vehicle and available seat information may be further posted on a website and available to passengers. The website may provide facility for the passengers to reserve an available seat on the vehicle and proceed to the nearest stopping location to embark on the autonomous public transportation vehicle.

Another feature provided by the real time parking lot analysis and management system is through designating a landing space in a parking lot for an unmanned aerial vehicle to be used by the unmanned aerial vehicle to land in case of bad flying weather condition, or for pickup and delivery of packages.

In addition to identifying available and occupied parking spaces in a parking lot the real time parking lot analysis and management system can also designate some of the available parking spaces for handicap parking, parking space where electrical vehicles can charge their batteries, restricting a parking space for other use than automobile parking such as storing construction material, or reserving the space for drivers who reserve a parking space, for specific vehicles such as employee vehicles or security vehicles, or motorcycles and bicycles.

The real time parking lot analysis and management system depending on multiple inquiries on available parking spaces from multiple automobile operators in a specific locality can have the central processing unit, when previously authorized by the parking lot, alter a parking fee associated with the parking lot for attracting potential automobile operators in search of the parking space to increase revenue for the parking lot on a real time basis, and when there are not as much demand for parking space the reported parking fee by the central processing unit is reduced compared to close by parking lots.

The central processing unit further can attains information as to traffic flow in a locality using department of transportation website or street based traffic video cameras, from Google Traffic application recognizing traffic flow based on general information provided from driver's mobile phone report to Google Map application, individuals, the dedicated computing platforms, the operators of automobiles with the dedicated computing platform, the unmanned aerial vehicle, or a combination thereof to predict demand for available parking spaces in a locality and use the information for altering displayed parking fee in the local parking lots.

A mobile dedicated computing platform such as a mobile phone can be used to inquire from the central processing unit as to the parking space where the associated automobile is parked.

The dedicated computing platform, using a speed of moving of the dedicated computing platform can decide if the dedicated computing platform is in the automobile or it is on the automobile operator, such as when the vehicle operator carries a mobile dedicated computing platform such as a mobile phone with her when departing the automobile. When the dedicated computing platform is on the automobile operator while walking, the dedicated computing platform will not report to the central processing unit that the automobile has departed the parking space. Furthermore the dedicated computing platform on the automobile operator will not report departure of the automobile to the central processing unit, unless the dedicated computing platform recognizes its location within the parking lot after the automobile operator walks back to her automobile for departing the parking space.

In case there are multiple dedicated computing platforms in a single automobile where several people with mobile phone activated dedicated computing platforms are in the single automobile, the central processing unit can combine the geographic location report by all the dedicated computing platforms in the single automobile and associate all the reports to a single parking space when the automobile is parked in the parking space.

A business method and aspect that real time parking lot analysis and management provides is when a central processing unit identifying available parking spaces can guide a dedicated computing platform in an automobile inquiring about available parking spaces toward specific parking zones to increase traffic flow to a specific adjacent commercial space when the commercial space pays a fee for increased traffic to their locality to be enabled by the central processing unit influencing a bias for providing information on available parking spaces in the preferred locality.

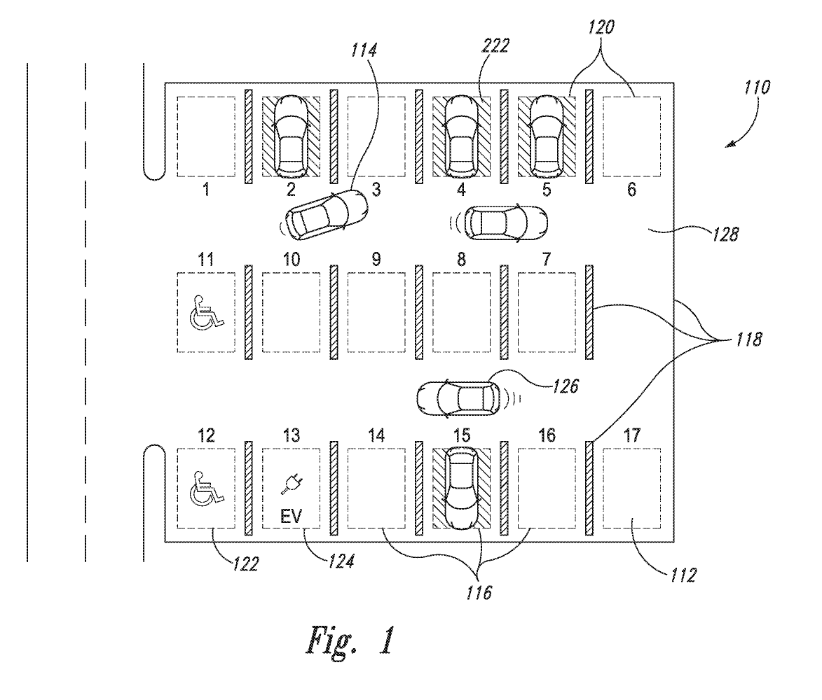

Referring to FIG. 1, an illustration of a parking lot 110 superimposed by a digital parking space map 116, an image of a real map of the parking lot 118 and an associated general parking zone 128 as displayed on a dedicated computing platform 242 is shown with digital parking space map 116 superimposed on the parking lot 110. FIG. 1 further show automobiles 114 as parked or in passing in the parking lot 110 in order to show a real time snap shot of what conditions may be in a parking lot. Parking spaces 120 are shown where some are available parking spaces 112, and some are occupied parking spaces 222, where the central processing unit 240 identifies the parking space as occupied in the digital parking space map 116. In FIG. 1 an automobile 114 is shown entering parking space 120 in parking space number 3 and an automobile 114 is shown as a slow loitering vehicle 126 passing an occupied parking space 222 at parking space 120 number 15. The digital parking space map 116 further shows parking space 120 number 11 and 12 as dedicated handicap parking spaces 122, and parking space 120 number 13 as an electrical vehicle parking space 124 dedicated to electrical vehicle where there is an electrical charging station is provided for electrical vehicles to recharge their batteries.

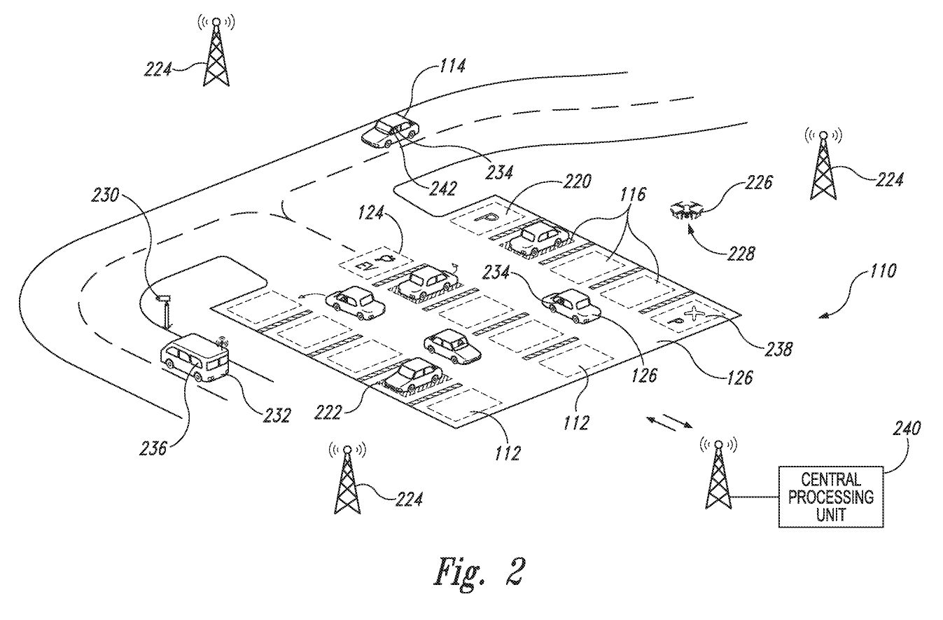

Referring to FIG. 2, this figure is an illustration of a parking lot 110 superimposed by a digital parking space map 116 and cell phone towers 224 also showing an autonomous public transportation vehicle 232. FIG. 2 shows a plurality of cell phone towers 224 that are used as radio frequency sources used by a dedicated computing platform 242 in a triangulating procedure in a geographic localizing program to calculate position of the dedicated computing platform.

FIG. 2 further illustrates an automobile 114, the operator of the automobile 234 and a dedicated computing platform 242 inside the automobile. A traffic camera 230 is shown on the side of the road which is used to provide traffic and road condition information communicated to the central processing unit 240, for the central processing unit to include the information in its analysis as to traffic flow and road condition in relation to calculating demand for available parking spaces 112 in the proximate vicinity parking lots 110 to adjust the area parking fees to be displayed on the dedicated computing platforms 242 inquiring about available parking spaces 112. The central processing unit 240 further attains information as to traffic flow in a locality using department of transportation website or street based traffic video cameras 230, from Google Traffic application recognizing traffic flow based on general information provided from driver's mobile phone report to Google Map application, individuals, the dedicated computing platforms 242, the operators of automobiles 234 with the dedicated computing platform 242, the unmanned aerial vehicle 226, or a combination thereof. As detailed previously, the central processing unit 240 after considering the traffic flow in the area and accordingly establishing a real time parking rate for the parking lots 110 with addresses in the area provides the parking lot 110 addresses and their associated parking fees to the dedicated computing platform 242 when responding to an inquiry about available parking spaces 112.

FIG. 2 further illustrates the central processing unit 240 in communication with dedicated computing platforms 242. Furthermore the digital parking space map 116 superimposed on the image of the parking lot 110, displays a stopping location 220 in an available parking space 112 to be used by the autonomous automobile 232 which may be an autonomous public transportation vehicle 232 for safe passengers embarking and getting off the autonomous public transportation vehicle 232. Furthermore the autonomous public transportation vehicle 232 illustration shows a plurality of available seats, where the number of available seats 236 is communicated to the central processing unit. The central processing unit then makes the number of available seats 236 and the address of the stopping locations 220 available on a website for passenger to see and proceed to the nearest stopping location 220 to get on the autonomous public transportation vehicle 232. The website further provides an option for passengers to reserve an available seat 236, upon which the total number of available seats 236 on the autonomous public transportation vehicle 232 on the website is reduced accordingly.

FIG. 2 further illustrate a landing space 238 for an unmanned aerial vehicle 226 on the digital parking space map 116 superimposed on the image of parking lot 110. This landing space 238 for an unmanned aerial vehicle 226 is to be used for the unmanned aerial vehicle 226 to land in case of adverse flying condition weather, or for pickup and delivery of packages by the unmanned aerial vehicle 226. FIG. 2 also illustrate a camera 228 coupled to the unmanned aerial vehicle 226 to be used for taking images of the parking lot 110 to identify available parking spaces 112 and occupied parking spaces 222. The information on available parking spaces 112 and occupied parking spaces 222 are transmitted from the unmanned aerial vehicle 226 to the central processing unit 240 via an antenna on the unmanned aerial vehicle 226.

FIG. 2 further illustrate a parking space 120 dedicated as an electrical vehicle charging space 124. FIG. 2 also illustrate available parking spaces 112, occupied parking spaces 222, parked automobiles 114, automobiles 114 entering and exiting parking spaces 120, and slow speed loitering automobiles 126 with the operator of the automobile 234 inside the automobile 114.

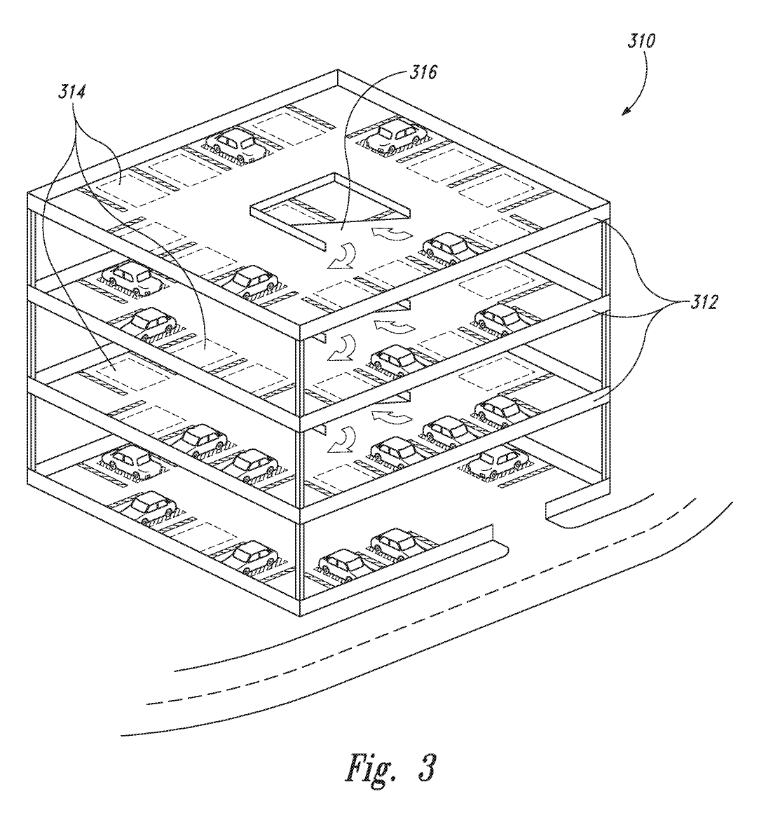

Referring to FIG. 3, this figure is an illustration of a multi-level parking lot 310. In FIG. 3, the digital parking space map comprises a three dimensional sketch of multi-level floors parking lot 314. FIG. 3 further shows a plurality of different levels from ground 312, and the passage from each floor to the next floor is illustrated presenting a limited area 316, where the specific characteristic of this passage area being a limited area 316 is utilized in identifying movement from one floor to another floor by the automobile 114 moving and turning in a small radius spiral road.

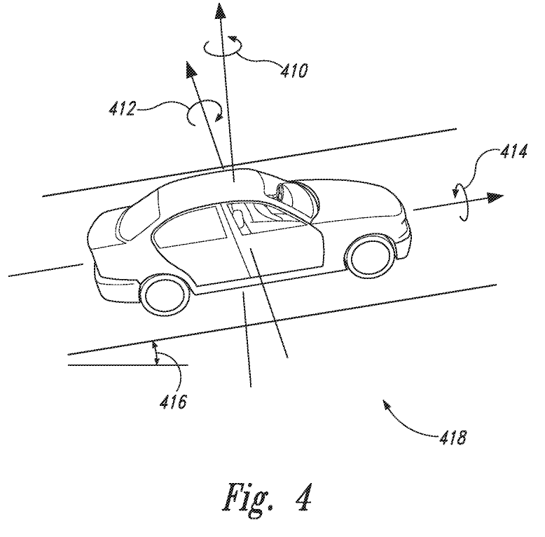

Referring to FIG. 4, is an illustration of an automobile driving on an inclined road showing a change of pitch 416 of the car while traveling on the inclined road, further showing roll 414, pitch 412 and yaw 410 orientation of the automobile. FIG. 4 is an illustration of pitch 412, yaw 410, and roll 414 change of the automobile, indicating movement of the automobile to a different floor level 418 in a multi-level parking lot 310.

One of the methods for identifying moving of the automobile 114 between floors in a multi-level parking lot 310 is by statistically calculating probability of moving between floors based on spatial location of the automobile 114 and speed of the automobile, where with the automobile 114 moving in a very limited area 316, yet maintaining a constant linear speed, indicating that the automobile 114 is moving between floor, and not moving across a single floor. To make the calculation resulting in identifying movement between floors, the dedicated computing platform 242 on each automobile 114 is equipped with a gyroscope or a three axis orthogonal accelerometer system to detect Yaw 410, Pitch 412, and roll 414 of the dedicated computing platform 242 and the automobile 114 within which the dedicated computing platform 242 resides. In this calculation where the automobiles moves from a floor to the next floor the dedicated computing platform 242 will go through a change of its yaw 410, pitch 412 and roll 414 identifying a movement of the automobile to a different floor level.

Utilizing the gyroscope or the three axis orthogonal accelerometer system to detect Yaw 410, Pitch 412, and roll 414 of the dedicated computing platform 242 the dedicated computing platform 242 can further identify a change of yaw 410 of the automobile 114 between about less than or equal to 90 degrees and a reduction of the speed of the automobile 114 to zero indicating that the automobile 114 has parked in an available parking space 112, and a change of yaw 410 of the automobile 114 about 180 degrees and a continued movement of the automobile 114 indicating that the automobile 114 has turned around.

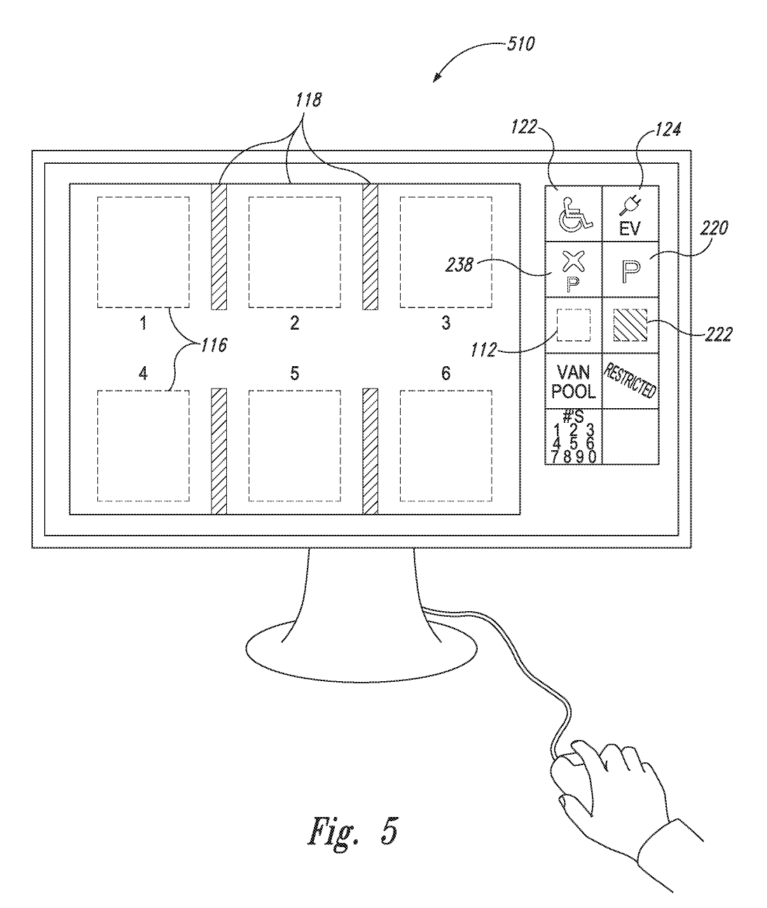

Referring to FIG. 5 is an illustration of a computer connected to a web based sketching tool software 510. FIG. 5 illustrate creation of a digital parking space map 116 superimposed and an image of a real map of the parking lot 118. FIG. 5 further illustrate a sample side bar showing sample specific parking space 120 templates to be installed on the parking spaces 120 illustrated on the digital parking space map 116 showing handicap specific 122, electrical vehicle parking space 124, landing space 238 for unmanned aerial vehicle 226, stopping location 220 parking space, an available parking space 112, an occupied parking space 222, a parking space template indicating vanpool, a parking space indicating restricted parking space, and a numbering template, where the operator of the web based sketching tool software 510 can pick numbers from to assign to the parking spaces on the digital parking space map 116.

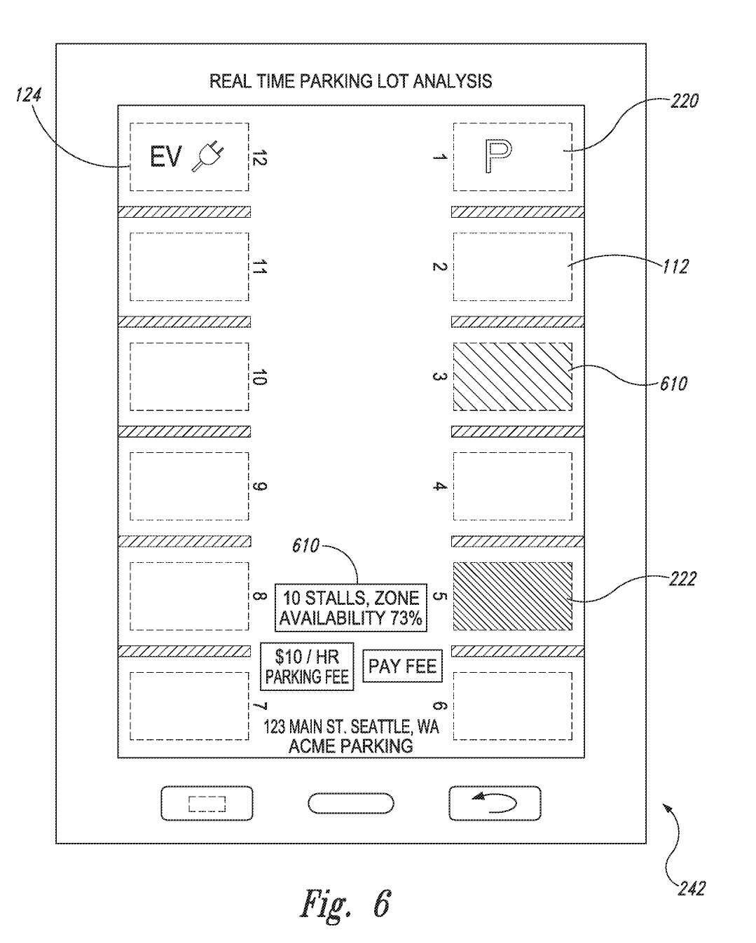

Referring to FIG. 6 is an illustration of a dedicated computing platform 242. FIG. 6 illustrates the real time parking lot analysis and management software package display shown on the dedicated computing platform 242 display. FIG. 6 shows a cellular phone embodiment of the dedicated computing platform 242. A dedicated computing platform 242 can further comprise a laptop, or a tablet. On the display a section provides information as to the address of the parking lot 110, where the dedicated computing platform 242 has inquired about available parking spaces 112. The display further includes information on available stalls of parking spaces 120. The display shows an occupancy probability 610 in a statistical presentation of percentage of available parking spaces 112 in the parking lot 110 zone including all the parking spaces 120 in the parking lot 110. The display further includes a parking rate fee associated with the parking lot 110. Furthermore the display includes a button for the operator of the automobile 234 to pay the parking fee upon parking in an available parking space 112 in the parking lot 110.

FIG. 6 further illustrates an image of the real map of the parking lot 118, with the associated digital parking space map 116 superimposed on the real map of the parking lot 118. The digital parking space map 116 shows an electric vehicle parking space 124, a parking space 120 dedicated to a stopping location 220 for an autonomous public transportation vehicle 232, a plurality of available parking spaces 112, a possibly occupied parking space with an occupancy probability 610, and an occupied parking space 222.

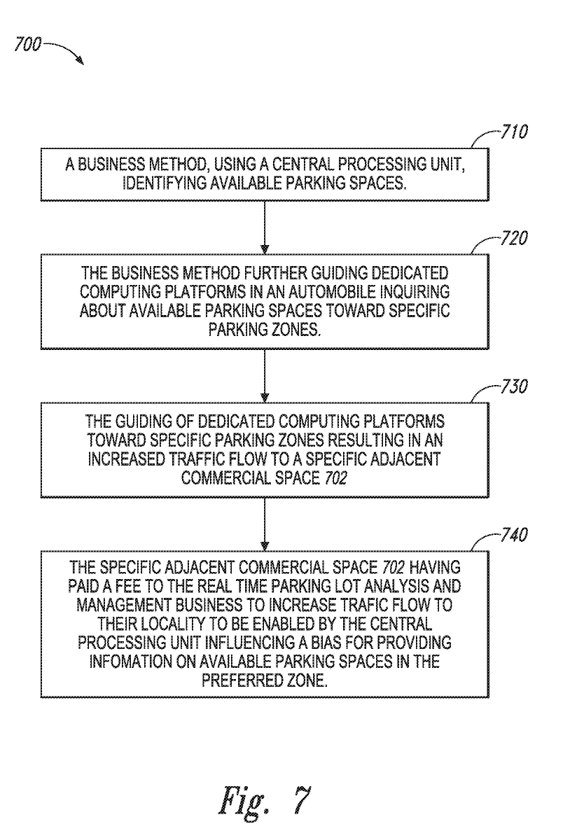

Referring to FIG. 7 is an illustration of a business method 700 for bias guidance of inquiring dedicated computing platform 242 to a specific parking zone for a fee. Step 710 of business method 700 outlines a business method 700 using a central processing unit 240, identifying available parking spaces 112.

Step 720 of business method 700 outlines the business method further guiding dedicated computing platforms 242 in an automobile 114, inquiring about available parking spaces 112 toward specific parking zones.

Step 730 of business method 700 outlines the guiding of dedicated computing platform 242 toward specific parking zones resulting in an increased traffic flow to a specific adjacent commercial space 702.

Step 740 of the business method 700 outlines the specific adjacent commercial space 702 having paid a fee to the real time parking lot analysis and management business to increase traffic flow to their locality to be enabled by the central processing unit 240 influencing a bias for providing information on available parking spaces 112 in the preferred zone.

As various modifications could be made in the construction of the apparatus and system and its method of operation herein described and illustrated without departing from the scope of the present disclosure, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

We claim:

1- A method to find and report an available parking space in a parking lot, comprising:
providing a software application on a memory device coupled to a processor on a dedicated computing platform in an automobile, the dedicated computing platform further including:
a geographic localizing program,
a mapping software providing a digital parking space map superimposed on a real map of the parking lot,
a statistical analysis software calculating probability of occupied or available status of a parking space based on data provided by the dedicated computing platform,
a transceiver transmitting availability status of the parking space in the parking lot to a central processing unit,
where the central processing unit further transmits availability status of the parking spaces in the parking lots to the dedicated computing platform, and
enabling the dedicated computing platform to report on available parking spaces in the parking lots.

2- Method of claim 1, where
the geographic localizing program using a global positioning system or a triangulating system based on radio frequency sources including cellular phone towers, identifies geographic position of the dedicated computing platform,
where the digital parking space map superimposed on the real map of the parking lot is created using a web based sketching tool software mapping a configuration of the plurality of parking spaces on the real map image of the parking lot, resulting in digital representation of individual parking spaces in the parking lot,
where the software algorithm is capable of assigning occupied or available status to each individual parking space based on a statistical analysis of information provided to it,
where a plurality of automobiles are each equipped with the dedicated computing platform equipped with the transceiver communicating with the central processing unit, where the dedicated computing platform is in communication with the central processing unit,
where the dedicated computing platform can identify geographic location of the automobile and can sense movement, speed, acceleration, temporary and permanent stoppage of the automobile,
where the dedicated computing platform transmits to the central processing unit when the automobile is parked in a specific parking space on the parking lot, and will also inform the central processing unit when the automobile leaves the specific parking space, providing a definite occupied or available status for the specific parking space,
where the dedicated computing platform can identify if the automobile is slow loitering about the specific parking space in the parking lot and moving on, indicating that the specific parking space may be occupied, even though another automobile with the dedicated computing platform has not reported parking in that specific parking space providing a definite occupied or available status of the specific parking space,
where a repeated slow loitering report from a plurality of dedicated computing platforms provides a statistical probability that the specific parking space is occupied, for updating the status of the specific parking space as occupied as part of updating parking space status for all the parking spaces of the parking lot on the central processing unit, and
where the software application in communication with the central processing unit can provide real time parking space availability in the parking lot to the operator of the automobiles equipped with a dedicated computing platform.

3- Method of claim 2, where the parking lot comprise a plurality of different levels from ground, and
where the dedicated computing platform on each automobile is equipped with a pressure sensor, capable of identifying height variation due to spatial location of the automobile in different levels of the parking lot based on increasing or decreasing atmospheric pressure, further distinguishing the random instantaneous atmospheric pressure variation from continuous increase or decrease in atmospheric pressure, identifying location of parking spaces on different parking levels of the parking lots with multi-level floors.

4- Method of claim 3, where the central processing unit provides a two dimensional sketch of the ground level parking lots and a three dimensional sketch of multi-level floors parking lots specifying individual parking spaces on the ground level or above ground floors and corresponding available parking spaces to the dedicated computing platform on each automobile inquiring about available parking spaces.

5- Method of claim 3, where an alternative to a pressure sensor on the dedicated computing platform to identify moving between floors in a multi-level parking lot is by statistically calculating probability of moving between floors based on spatial location of the automobile and speed of the automobile, where with the automobile moving in a very limited area, yet maintaining a constant linear speed indicating that the automobile is moving between floor, and not moving across a single floor.

6- Method of claim 3, where the dedicated computing platform on each automobile is equipped with a gyroscope or a three axis orthogonal accelerometer system to detect Yaw, Pitch, and roll of the dedicated computing platform and the automobile within which the dedicated computing platform resides.

7- Method of claim 6, where the automobiles moving from a floor to the next floor will go through a change of its yaw, pitch and roll identifying a movement of the automobile to a different floor level.

8- Method of claim 6, where a change of yaw of the automobile between about less than or equal to 90 degrees and a reduction of the speed of the automobile to zero indicates that the automobile has parked in a parking space, and a change of yaw of the automobile about 180 degrees and a continued movement of the automobile indicates that the automobile has turned around.

9- Method of claim 1, where the method to find and report the available parking space in the parking lot further includes an unmanned aerial vehicle, using a camera for identifying the occupied parking spaces in the parking lot, an autonomous automobile using cameras detecting occupied parking spaces in the parking lot, or using a radio frequency detector identifying presence of dedicated computing platforms within or proximate to the parking space in the parking lot.

10- Method of claim 2, where the central processing unit has information on address of the parking lots and associated parking rates to be provided to the dedicated computing platform when responding to an inquiry about available parking spaces.

11- Method of claim 10, where the dedicated computing platform is capable of making electronic payments for parking in the parking lot to an account of the parking lot registered with the central processing unit.

12- Method of claim 10, where depending on multiple inquiries on available parking spaces from multiple automobile operators in a specific locality the central processing unit, when previously authorized by the parking lot, can alter a parking fee associated with the parking lot for attracting potential automobile operators in search of the parking space to increase revenue for the parking lot on a real time basis, and
where when there are not as much demand for parking space the reported parking fee by the central processing unit is reduced compared to close by parking lots.

13- Method of claim 10, where the central processing unit further has information on specific parking spaces in the parking lot dedicated to handicapped parking, electric charging station parking spaces for electric automobiles, specific time limits on parking spaces, temporary unavailability of the available parking space used for specific non-parking related activity such as storage of equipment, or a combination thereof, to be provided to the dedicated computing platform upon inquiry as to available parking spaces.

14- Method of claim 10, where the central processing unit attains information as to traffic flow in a locality using department of transportation website or street based traffic video cameras, from Google Traffic application recognizing traffic flow based on general information provided from driver's mobile phone report to Google Map application, individuals, the dedicated computing platforms, the operators of automobiles with the dedicated computing platform, the unmanned aerial vehicle, or a combination thereof.

15- Method of claim 2, where the central processing unit assigns parking space numbers to each identified parking space as mapped on a parking area in the parking lot, for specific allocation and reporting of occupied or available parking spaces in response to an inquiry from the dedicated computing platform on available parking space.

16- Method of claim 2, where an operator of the automobile with the dedicated computing platform can further provide information to the central processing unit as to status of individual parking spaces in the parking lot as to it being occupied or available, in addition to the dedicated computing platform automatic reporting of the automobile slow loitering and moving on from the individual parking space.

17- Method of claim 2, where the dedicated computing platform can autonomously identify if the automobile is parking in the parking space or leaving the parking space based on deceleration or acceleration movement of the automobile or movement time delays or a specific speed threshold.

18- Method of claim 2, where the central processing unit can provide information as to where the automobile is parked upon inquiry from the dedicated computing platform when the automobile operator does not remember where the automobile operator had parked the automobile in the parking lot.

19- Method of claim 2, where the dedicated computing platform, using a speed of moving of the dedicated computing platform can decide if the dedicated computing platform is in the automobile or it is on the automobile operator and when the dedicated computing platform is on the automobile operator while walking, the dedicated computing platform will not report to the central processing unit that the automobile has departed the parking space.

20- Method of claim 19, where the dedicated computing platform on the automobile operator will not report departure of the automobile to the central processing unit, unless the dedicated computing platform recognizes its location within the parking lot after the automobile operator walks back to her automobile for departing the parking space.

21- Method of claim 2, where if there are multiple dedicated computing platforms in a single automobile where several people with a mobile phone activated dedicated computing platforms are in the single automobile, the central processing unit can combine the geographic location report by all the dedicated computing platforms in the single automobile and associate all the reports to a single parking space when the automobile is parked in the parking space.

22- Method of claim 2, where the statistical probability of available parking spaces in a zone, as reported by the central processing unit to dedicated computing platforms inquiring about available parking spaces, takes into account occupancy probability of a general parking zone adjacent to a favorable area in statistical calculation of available parking spaces in the zone.

23- Method of claim 1, where the available parking information is transmitted to an autonomous public transportation vehicle,
identifying an available parking or stopping location in a desired vicinity on a route of the autonomous public transportation vehicle, and
enable safe embarking and egress of passengers.

24- Method of claim 23, where the autonomous public transportation vehicle further transmits a number of available seats in the autonomous public transportation vehicle, the route of the autonomous public transportation vehicle, and stopping locations of the autonomous public transportation vehicle, to be posted to a website, and
where passengers can reserve the available seats on the autonomous public transportation vehicle and proceed to the nearest stopping location to embark on the autonomous public transportation vehicle.

25- A business method, comprising:
A central processing unit identifying available parking spaces can guide a dedicated computing platform in an automobile inquiring about available parking spaces toward specific parking zones to increase traffic flow to a specific adjacent commercial space when the commercial space pays a fee for increased traffic to their locality to be enabled by the central processing unit influencing a bias for providing information on available parking spaces in the preferred locality.
